(19) United States
(12) Patent Application Publication
(10) Pub. No.: US 2003/0222977 A1
(43) Pub. Date: Dec. 4, 2003

(54) Intelligent system and 3D virtual object generator

(76) Inventor: Kazutora Yoshino, Madison, WI (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/161,180

(22) Filed: Jun. 3, 2002

(51) Int. Cl. H04N 13/04; H04N 15/00; G06T 15/00

(52) U.S. Cl. 348/51

(57) ABSTRACT

This system of the invention can learn, think, and create as human can do, and communicate with users, devices, systems, and environment visually, verbally, and by other means. This device can generate the 3 dimensional image and objects or images in real time (run time) by viewed by the multiple users without special glasses in the space only by light safe to user. Optionally the device can change the size and position of 3 dimensional image and objects and the device can have the virtual 3 dimensional volume infinite distance. Running the virtual light point means in the 3 dimensional space very fast (about 70×70 frames/sec or above) causes the resultant light image creates 3 dimensional image. The virtual light point means was used to describe the light diverging at the point in the space. When this follows to the surface of desired 3 dimensional images in space, it would generate the virtual image of 3 dimensional image optically. The same concept can be applied to the electrical field, Coulomb field, and physical fields. By object-touch generating means such as force feedback joystick, user can feel of force from the virtual object. The intelligent control means such as neural networks and a super intelligent control means such as learning system together with input devices means such as sensors video cameras and speakers and output devices means such as a robot hands and speakers enable the device to interact with users, the other devices, and environment.

### FEDERALLY SPONSORED RESEARCH

Not Applicable

### SEQUENCE LISTING OR PROGRAM

Not Applicable

### BACKGROUND OF INVENTION

1. Background—Field of Invention

This invention relates to the artificial intelligence such as an artificial neural network and the image display devices such as 3DTV, hologram, stereo display device that are used for displaying the 3 dimensional object or images.

2. Background—Description of Prior Art

In the conventional way, it was difficult to display the 3 dimensional object or images in real time (run time) by viewed by the multiple users without special glasses in the space only by light. So devices such as TV are showing the converted 2 dimensional image from the 3 dimensional objects. Also, the virtual headsets are showing the two different images to each eye of users by screens to create the 3 dimensional images. Also, holograms are showing 3 dimensional image, but these images are difficult to be changed in real time (run time). Also, the method to project the 2 dimensional image to rotating plate to create 3 dimensional image are difficult to show the 3 dimensional virtual images in the space only by light (it is difficult to project 3 dimensional image in the air and to resize the 3 dimensional image). Also, the method to project the 2 dimensional image to plurality of semi-transparent plates to create 3 dimensional image are difficult to project the 3 dimensional virtual images in the space only by light. U.S. Pat. No. 5,394,202 (Deering, 1995) and U.S. Pat. No. 5, 907,312, (Sato, et al., 1999) release some of these methods.

In Japanese Patent No.288957 or H01-193836 (Felix Gashia, et al, 1989) shows the way to make 3 dimensional image by project the 2 dimensional image to rotating plate. This put red, blue, green laser beam together to light fiber, and run the light to make the 2 dimensional image on the angled and rotated plate so that it would show the 3 dimensional image as a result. But, this one is rotating fast enough to be able to hurt users. And therefore, it is not suitable for user to touch the 3 dimensional image created by this device. Also, this by itself is almost impossible to show the image in the space only by light.

In U.S. Pat. No. 3,647,284 (Virgil B Ethlgs, et al., 1972) show the method of showing 3 dimensional image made by the light that was originally scattered by an object. This device put two dish means facing each other. The top dish means has ring shape, that is it has a hole in the middle, and 3 dimensional image shows up over this hole when user put the object at the bottom of the bottom dish means. Each of dishes has reflecting material inside to reflect lights. But this device by itself would be unsuitable to show the real time (run time) 3 dimensional image because it is composed of two dishes.

In order to feel the touch or force to a virtual object, user used a force-feedback glove, a force-feedback joystick, a force-feedback handle, and general input device with solenoids to get a feedback force in the conventional ways. But in order to view the 3 dimensional virtual object, the users are often required to wear a virtual reality head set or special glasses such as shutter glasses and polarized glasses, colored glasses to interact with virtual objects. Otherwise, many users use a 2 dimensional screen that causes unrealistic environment with virtual reality. Also, some people feel cyber sick using a virtual reality head set, and special glasses.

The U.S. Pat. No. 5,742,278 (Chen, et al., 1998) shows the force feedback joystick with which user can feel the feedback force from the virtual reality environment. But this needs a 3 dimensional virtual display to make the experience of users more realistic.

In conventional way, there are many artificial intelligence types such as neural computers and expert system. These artificial intelligence works well in many fields of interest. But in case of interaction with users, the communication was often inefficient between artificial intelligence. This is mainly due to the lack of efficient communication between users and these artificial intelligent computer systems. Therefore, many people are waiting for real medium of communication such as a interactive 3 dimensional virtual object generator that creates 3 dimensional information for communication with linguistic information, motion information between users and artificial intelligence systems.

U.S. Pat. No. 5,546,503 (Abe, et al.,1996) shows the neural computer that can pattern recognize input information with multi-layer neural networks. U.S. Pat. No. 5,481,454 (Inoue, et al.,1996) shows the translation system of sign language. The system can pattern recognize input sign language and translate it. U.S. Pat. No. 6,353,814 (Weng, 2002) shows the learning machine and method. This machine learns by some interaction with environment and/or users.

But these computers are concentrated on the networking and they show a little of ways how to improve the interaction with users. Also, neither of these is integrated enough to work like a human brain. Therefore, neither of these gives an efficient way of receiving an information from users, devices, systems nor an efficient way to express the output information to users, devices, systems for interaction such as visual interaction and conversational interaction as human beings communicate each other.

Objects and Advantages

This invention has advantages relative to prior art in

1.This device of invention can learn, think, create like a human beings and communicate like a human beings.

2.User can view the mind/image this device of invention is thinking and interact with the mind/image directly as well as indirectly.

3.The device can operate the 3 dimensional virtual image-object by interacting with user on the image-object and by using computer input device means.

4.The device can imagine the object image and show it to the users when users give command vocally or visually.

5.The device can learn and improve itself acquiring new information/materials from users and the other information source.

6.The device can communicate with each other and users effectively.

7. The device can associate the information so that it would induce, deduce, guess, and create the desired result as far as the proper basis of the desired result is given to the knowledge base, and users other entities can get these results through the communication of their choice.

8. The device is integrated enough to work like a human brains and potentially exceeds the capacity of human brains.

9. The device can copy their acquired information to each other. thinking.

10.The device is safer and user-friendly to users

11.The device can display the 3 dimensional object or images in real time (run time)

12.The device can display the 3 dimensional object or images that can be viewed by the multiple users without special glasses

13.The device can display the 3 dimensional object or images in the space only by light.

14.The device can be used for longer operating time

15.The device can change the size and position of the 3 dimensional images

16.The device can display objects from plus infinite to minus infinite distance 3 dimensional volume.

17.The device can be made more inexpensively.

18.The device can create virtual touch to the multiple users without a headset or special glass, and the device can give more realistic interaction with user than 2 dimensional screen interaction.

### SUMMARY

The device of invention can learn, think, and create as human beings can do, communicate with users, devices, systems, and other entities as human beings do. The device of invention can display the 3 dimensional objects or images in real time (run time) by viewed by the multiple users without special glasses in the space only by light safe to user. Optionally the device can change the size and position of 3 dimensional objects or images and the device can have the virtual 3 dimensional volume infinite distance.

General concept of the intelligent system is to design and create the system that modifies and updates itself based on the information and knowledge and creates the new ideas to learn, think, and create.

General concept of the 3 dimensional virtual object generator is to run the virtual light point means in the 3 dimensional space so that the resultant light image creates 3 dimensional image. The virtual light point means was used to describe the light diverging at the point in the space. When this follows to the surface of desired 3 dimensional images in space very fast (about 70×70 frames/sec or above), it would generate the virtual image of 3 dimensional image optically. The same concept can be applied to the electron beam. Also, the device may be able to create the virtual force/surface using Coulomb force so that user can touch to the virtual object. This can be added to the virtual image so that it would be 3 dimensional virtual object.

To run the virtual light point means in the 3 dimensional space so that the resultant light image creates 3 dimensional image, we need to create the virtual light point means.

There are examples,

1) One is to project light beam to a diffusing material means. A diffusing material means include the half-clear plate (material), light reflective surface material, liquid crystal, acoustic crystal, or anything to diffuse light. The half-clear plate can scatter the light when the light beam is projected on the half-clear plate from the back. A single or combined lens can generate the virtual light point means. When light is projected to a 2 dimensional diffusing plate means, each point on the 2 dimensional plate creates the diffusing material means.

2) Move 2 dimensional image means quickly (70 frames/sec for each 2 dimensional image or above) to generate 3 dimensional image. 2 dimensional image means include Liquid Crystal, 2 dimensional image projected by light.

3) Quick movement of the light reflection. When a mirror is moved to reflect light so that the light can cross the same point in the space, it would produce the virtual light point means.

4) Reflecting material means such as mirror can create the virtual light point means when a point light is present in front of the Reflecting material means.

5) When light pass through the Acoustic Crystal Lens means, the light can converge at the different position that would be the virtual light point means. Operation of different voltage on the Acoustic Crystal Lens means provide the different position of the virtual light point means.

6) A single lens, or the combination of lenses can create the virtual light point means. When concave and concurve lens are put together and the light is projected, this can give adjustable virtual light point means by shifting one of those lenses.

7) An eye of creatures such as a caw, a rubber lens can be used as lens accepting light. These can be physically pushed or pulled to change the focus point therefore the position of the virtual light point means. By physically pushing or pulling these lenses, the virtual fight point means moves.

A single or combination of lenses can keep the same size of image or change the size of the image.

### DRAWINGS

Drawing Figures

FIG. 1 (A1) shows the example of the intelligent system diagram/flowchart that is like a human brain and that controls itself interacting with devices, systems, and human beings through visual information, verbal information, sensing information, environment information, and outside information.

FIG. 1 (AA1) shows the example of a contradiction updating system.

FIG. 1 (AA2) shows the example of the neural network method for neural network/logic flow chart.

FIG. 1 (AA3) shows the genetic algorithm for neural network.

FIG. 1 (AA4) shows the generalized generalizing method.

FIG. 1 (A) shows the example of the 3 dimensional image display for the combination of tilted rotating plate with 2 dimensional image, controller means, and the image projector means.

FIG. 1 (B) shows the example of the 3 dimensional image display for the combination of solenoid means with 2 dimensional screen, controller means, and the image projector means.

FIG. 1 (C) shows the example of the 3 dimensional image display for the combination of light beam emitters such as laser light emitter and the gas, liquid, solid medium to create the fast moving brightest virtual light point.

FIG. 1 (D) shows the example of the movement of 2 dimensional image created on the screen.

FIG. 1 (E) shows the example of the 3 dimensional image display for the combination of the focus changeable lens means, controller means, and the image projector means.

FIG. 1 (E1) shows the example of the potential component for focus changeable lenses.

FIG. 1 (E2) shows the example of the 2 dimensional diverging light source on XY generator means.

FIG. 2 (A) shows the example of the device of FIG. 1 (A) with the size modifier.

FIG. 2 (B) shows the example of the device of FIG. 1 (B) with the size modifier.

FIG. 3 (A1) shows the example of the acoustic crystal lens that can change the focus point depending on the voltage applied.

FIG. 3 (A2) shows the example of the animal eye lens or clear or half clear rubber lens that can change the focus point by applying the force.

FIG. 3 (A3) shows the example of the combination of lenses to change the focus point by shifting one of the lenses.

FIG. 3 (A4) shows the example of the more complicated combination of lenses to change the focus point by shifting one of the lenses.

FIG. 3 (A) shows the example of the 3 dimensional image display for the combination of the focus changeable lens means, controller means, and the size modifier.

FIG. 3 (B) shows the example of the 3 dimensional image display for the combination of the shifting lens means focus changeable lens means, controller means.

FIG. 3 (C) shows the example of the 3 dimensional image display for the combination of the acoustic lens means focus changeable lens means, controller means.

FIG. 4 (A1) shows the example of the general view of this device interacting with user input means comprising a finger, a hand, and an pointing device.

FIG. 4 (A2) shows the example of the general view of this device interacting with user input means comprising a joystick and hand, and the output device means comprising force feed back joystick.

FIG. 4 (A3) shows the example of the general view of this device interacting with environment means such as users and other devices having activities such as talking, learning, thinking, judging, loving, moving, looking, manipulating, accepting new ideas. These can communicate each other such as teaching information each other.

FIG. 5 (A1) shows the example of parts and structure of the intelligent system and 3 dimensional virtual object generator.

FIG. 5 (A2) shows the angled picture of the example of the intelligent system and 3 dimensional virtual object generator.

FIG. 5 (A3) shows the symbolized picture of the example of the intelligent system and 3 dimensional virtual object generator.

FIG. 5 (A4) shows the example of the rotating tilted plate on the ring with a motor

FIG. 5 (A5) shows the example of the structure of image generating means comprising the coil with a core image emitter means, magnet means, and spring means.

FIG. 6 (A1) shows the example of the diagram of the component of the control part of this invention

FIG. 6 (A2) shows the example components of the intelligent systems.

FIG. 7 shows the example of the diagram of a dipole interaction with a atom. The thread hold and force between them.

FIG. 8 (A) shows the example of the device with the 3 dimensional virtual object generating means with input device means and the interactive force generator means.

FIG. 8 (B) shows the example of the input device means with a user's hand.

FIG. 8 (C) shows the example of the interactive force generator means.

FIG. 8 (D) shows the example of the dipoles of poles with a fingertip.

FIG. 8 (E) shows the example of the general view of the device with which user view and touch the virtual object and modify the virtual object.

FIG. 9 shows the example of the diagrams of examples of the 3 dimensional image generating means.

FIG. 10 shows the example of the diagrams of the examples of the 3 dimensional image generating means.

FIG. 11 (A1) shows the example flow chart of the device.

FIG. 12 shows the examples of the 3 dimensional image generating means.

### REFERENCE NUMERALS IN DRAWINGS

1 The second image generating means

2 The tilted rotating plate means

3 The 2 dimensional image generating means

4 Light source generating means

5 X-Y-Z controller means and/or intelligent system unit means

7 The 3 dimensional virtual image and object

8 The motor means

9 The encoder means

10 Light rays

11 The container means

12 The gear means

14 The column means

15 Core Image emitter means

16 The computer means

17 The Z-axis control means

18 The X-Y-axis control means and the 2 dimensional image generating means

19 The height (feed back information) checking means

20 The coil means

21 The magnet/Coil means

22 The spring means

23 3 dimensional image generating means

24 ferromagnetic means

25 The focus changeable lens means

26 The reflector means

27 The X-Y light emitter means

28 The focus changeable lens controller means

29 The solenoid means

30 The size modifier means (Type I)

31 The size modifier means (Type II)

32 The eye means

33 The ear means

34 The mouth means

35 The language means

37 The light source means

38 Users

39 The manipulating means

40 The moving means

42 the secondary virtual image

50 virtual point means

51 liquid crystal means

52 liquid crystal display

53 light fiber means

55 3 dimensional real object means

57 photo-sensor means

58 optical lens means

59 joint column means and bearing means

70 The input device means

71 The output device means

74 The input light interference pattern means

75 Recording &Converting Information means

76 Output proper interference pattern means

77 The image generating plate means

79 The direction changeable beam emitter

80 The interactive force generator means

81 The x-axis controlling means

82 The y-axis controlling means

83 The z-axis controlling means

84 The intensity controlling means

85 The x-y-z axis controller and intensity controller means

87 The computer means

88 The laser means

91 writer means

92 eraser means

100 coherent light ray

### DETAILED DESCRIPTION

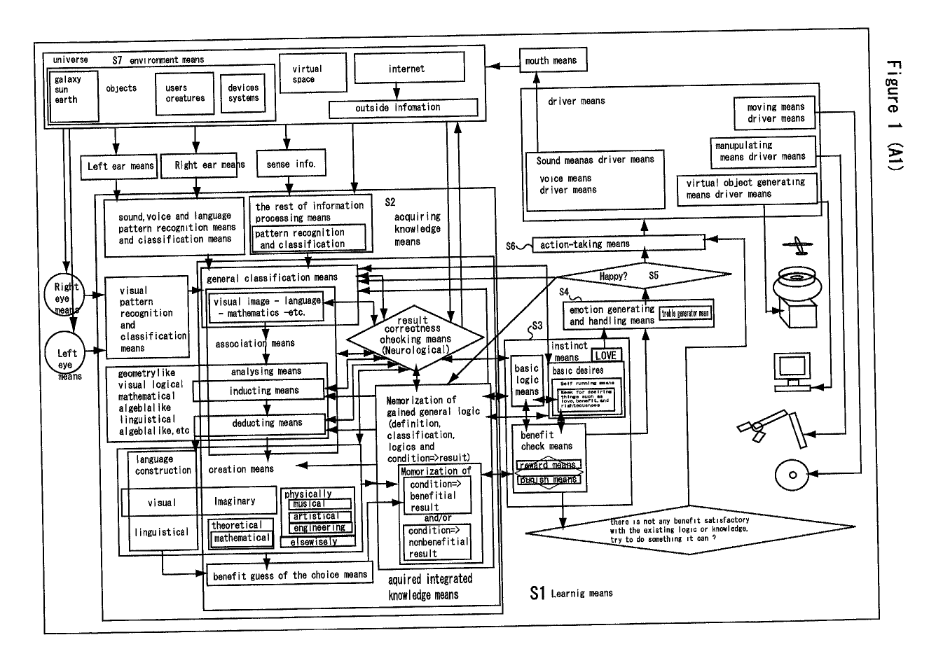

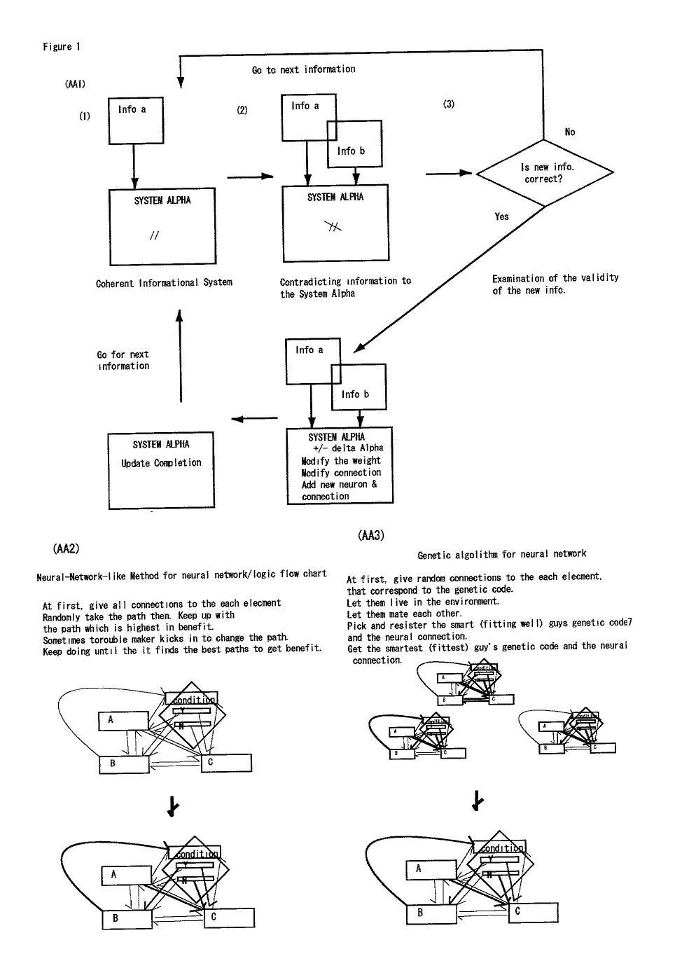

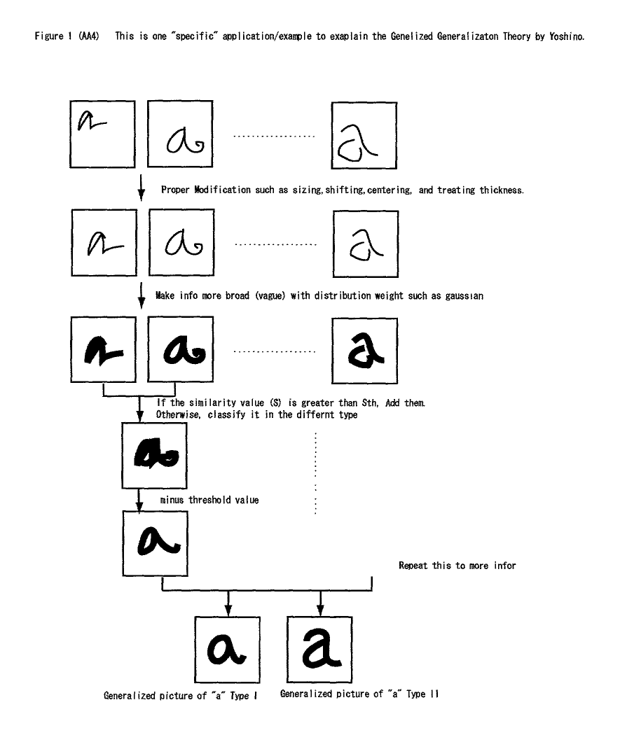

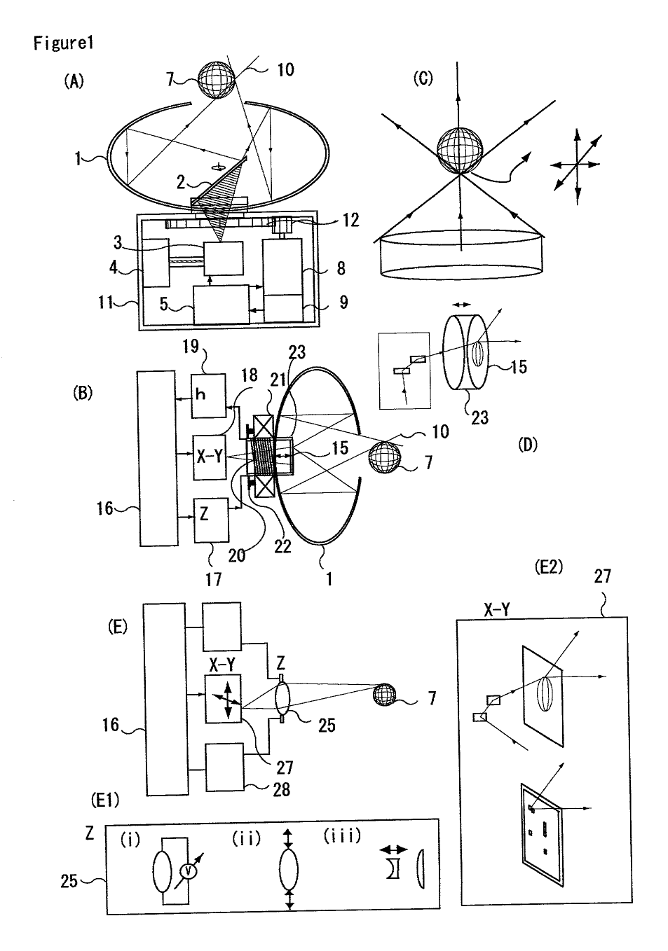

Description—FIGS. 1(A1), 1(A), 1(B), 1(C), 1(D), 1(E), 1(E1), and 1(E2)—Preferred Embodiment

A preferred embodiment of intelligent system and the 3 dimensional Virtual Image Generator invention is illustrated in FIG. 1 (A1), 1(A), 1(B), 1(C), 1(D), 1(E), 1(E1), and 1(E2).

I, Kazutora Yoshino is the designer of FIG. 1 (A1) that describes the whole/general picture of the human like intelligent system. I have already made prototype programs to do many parts of this system and examined the almost all parts of the system.

FIG. 1 (A1) is an example of composition/flowchart of intelligent control means by the inventor comprising

{S1} Learning means comprising

i) acquiring information

ii) self-modifiable pattern recognition and classification

iii) analyzing information

iv) checking information

v) memorizing information

vi) action-taking

vii) feedback the result information with conditional information and action information to acquiring information and repeat the process

These examples are:

computational learning theory <Chapter7, 4>

reinforcement learning <p528, 10>

Bayesian learning <p154-198>

Inductive learning <p529-531, 10>

Decision Tree Learning <p531-540, 10>,<p52-77,4>

Competitive and Cooperative Network <p100, 2>,<p224, 1>

Self-Organization, &Resonance <Chapter 6, 1>,<Chapter 9, 6>

Q learning <p167, p184, p187, 3>,<p599, 10>

Analytical Learning of Dynamic Induction and Deduction (AL-DID) <by Yoshino, found in 1982 examined in 1998> comprising

A=>B, B=>C, then A=>C . . . this is a common knowledge. But what comes after that? If there was a induced knowledge database saying A=>B=>C=> . . . =>Z, then “A=>Z” would be the logical guess. This is the dynamic operation of the combination of induction and deduction. The system keeps learning as much as it likes until the instinct or logical decision maker says it is enough.

{S2} acquiring knowledge means comprising

I) pattern recognizing and classifying means comprising

Machine Vision Algebra <UW lecture>

Unified theory of Cognition <5>

Kohnen model of neural computer <Chapter 11, 1>

Back propagation model of neural computer <Chapter 7, 1>

Recurrent model of neural computer <Chapter8, 6>

Q learning <p167, p184, p187, 3>,<p599, 10>

Time delay neural network <p158-162, 2>

Radial Basic Function Networks <p256, 8>

Navigation and Motion Planning <Chapter 25.6, 10>

LIVE, HAND-EYE, LED, CDL <3>

Nearest neighbor analysis <statistics, p124 2>

Mahal distance analysis <by Mahal.>

Statistical method of data handling <statistics for ANN>

Mathematical neural networks <9>

Natural Language Processing <Chapter24.7, p654, 10>

Character Classification Method (CCM)) <by Yoshino, found in 1980, examined in 1998> comprising how to pick the characters of information efficiently and classify the information using the proper-characters and non-proper-characters.

Advanced Language Processing (ALP) <by Yoshino, found in 1985, examined in 1998> comprising the usage of the mathematical/fuzzy/neural logic association of visual images and language for learning such as induction and deduction process together with the language understanding and construction. It uses the connectivity of the languages and visual languages to associate, analyze, and create the new languages. The relation R of the necessary conditions and sufficient conditions between visual image and language. This will connect to the Equation of Induction and Hypothesis (EIH) <by Yoshino>.

System Advancing Algorithm (SAA) <by Yoshino, found in 1989> comprising

the method to pattern recognition of the information with multi-layers of neurons that update the weight, connectivity and structural or mathematical connection itself in order to handle all type of complicated logical information that human being can handle. There are several methods to do this.

1) When the contradiction occurs, the system updates itself for new classification to create new neural connections or modify the existing connection to create a coherent information system. (Contradiction-Updating Method (CUM) named by Yoshino). The example of general picture is given in FIG. 1 (AA1). Kazutora Yoshino has already made prototypes to pattern recognize the general information using this method such as hand writing recognition, bio informatics data recognition, and picture recognition.

2) Create the all connections for the units of neurons. Then use the genetic algorithm to find the optimal connection. FIG. 1 (AA2)

3) Create the random connections, units, and weight with genetic codes, and they mates each other to optimize the connections, units, and weight due to the artificially natural selection gives the favor of survival to the fitting individuals to the environment (the condition we impose). FIG. 1 (AA3)

II) general classification means comprising

i) general classification of recognized and classified information

ii) classification of multi-interpretation means comprising

A1) self-classification of information

A2) classification of information by environmental correctness and influence

A3) classification of information by users, devices, and systems

A4) hybrid classification of information of A1), A2), A3), A4)

III) associating means comprising

i) association of the classified information

ii) association of the classified definition

iii) association of the classified logic

iv) association of new information to the existing information

v) association of information with emotion

General Generalization Theory and (GGT) <by Yoshino, found in 1989, examined in 1998> comprising the general theory of generalization, that is, “the super position of properly modified information of the original information minus the proper threshold value and the repeating this process generalize the information.” (FIG. 1 (AA4). Kazutora Yoshino completed this prototype as well. And it is working very well.

And Generalized Association Process (GAP) <by Yoshino, found in 1989, examined in 1998> uses the GGP for the association process to find the generally valid the association

IV) learning logic pattern means comprising

i) induction means comprising

A1) logical induction

Inductive and Analytical Learning method

Simple induction method

Equations of Induction and Hypothesis (EIH) <by Yoshino, found in 1975, examined in 1998> comprising

“((AB=ab, A=a)=>(A=a, B=b))” is the first guess. Also, “((AB=ab, AC=ac)=>(A=a, B=b, C=c)) is the highest Hypothesis Space (HHS).”

The following induction uses the combinations of EIH as a basic algorithm.

A2) mathematical induction

A3) visual induction

A4) linguistic induction

A5) pattern induction

ii) deduction means comprising

A1) logical deduction

Reasoning and Judgment Theory

Simple deduction method

A2) mathematical deduction

A3) visual deduction

A4) linguistic deduction

Deduction done by the linguistically logical space.

A5) pattern deduction

Advancing Learning Theory (ALT)<by Yoshino, found in 1989, examined in 1998>. As mentioned, the ALDID process dynamically A=>B, B=>C, then A=>C and A=>B=>C=> . . . =>Z, then guess “A=>Z” would come. But real world is full of contradictions. Advancing Learning Theory is the theory of contradiction embedded system. ALT is the theory to create the coherent system for the neural network. As long as the probability of classical/fuzzy/neural logic is working for the desire of the individual, it is regarded as ok. So perfectly contradicting idea can exist in the systems mind as coherent as long as it is giving a enough befit to the system. Technically speaking, the neurons construct the structure of neural/fuzzy/classical probable connections and embed the contradicting logical connections for the highest (optimal) benefits. The theory is suitable for the reality of this world in general since some of logic is very “soft” (not perfectly certain) in actual life.

V) result correctness checking means comprising

i) checking if result is correct relative to self known information

ii) checking if result is correct relative to outside known information

VI) memorizing means comprising

memorization of information means comprising

i) definition

ii) classification

iii) logics

iv) condition, then result

v) condition, then beneficial result

vi) condition, then non-beneficial result

VII) creative means comprising

i) vision construction

visual images creation

ii) language construction

iii) logic construction

iv) hypothesis construction

FOCL Search, FOIL Search <p361, p287, 4>

The Hypothesis-Hyper-Plane Theory <by KAZ Yoshino, found 1989, examined 1998> comprising the pattern recognition, induction, deduction of the coherence of the information having an algebra of the fittingness in a hyper plane.

VIII) choices generation thought experiments with benefit guess of the choices

{S3} instinct means comprising

I) basic desire

II) basic logics

III) motivation to satisfy said basic desire

IV) benefit checking means

i) reward checking

ii) punishment checking

{S4} emotion handling means comprising

I) promotion of desired result

II) priority making

III) selection of highest priority

IV) balance checking of benefit and punish

V) happiness checking

{S5} decision making means comprising

decide if the system should take the action

{S6} action taking means comprising

I) output driver means comprising

A1) sound driver

A2) image driver

A3) language driver

A4) manipulating driver

A5) moving driver

II) satisfaction checking means comprising checking if the result is satisfactory

III) feedback to the knowledge database about the condition, action, and the result

{S7} environment means comprising

I) physical entity

i) users and creatures

ii) systems and devices

iii) physical materials

iv) computers

v) universe

II) virtual entity

i) virtual mind space created by individual

A1) imaginary space of other people, devices, systems.

A2) thinking space other people, devices, systems.

A3) self-meditating space other people, devices, systems.

ii) cyber space

iii) information

iv) happiness space

v) spiritual space

vi) truth space

The 3 dimensional Image Generator of the type of FIG. 1(A) has a light source generating means {4} that produce the color light beams that would be used for the 2 dimensional image generating means {3}. The X-Y-Z controller means {5} controls the synchronizing 2 dimensional image generating means {3} and the Z-axis generator means. The Z-axis generator means comprises: the tilted rotating plate means {2}, gears means {12}, motor means {8}, encoder means {9}. The tilted rotating plate means {2} may be made of half-transparent diffuser or direct 2 dimensional image generator means such as LCD display. The computer means {16} can be included in The X-Y-Z controller means {5} or outside of The X-Y-Z controller means {5} . The X-Y-Z controller means {5} let the motor mean {8} rotate the gear means {12} so that the tilted rotating plate means {2} rotates properly. Also, The X-Y-Z controller means {5} receives the information of what angle the rotation is from the encoder means {9} so that The X-Y-Z controller means {1} can make a proper decision how much the motor means {8} should rotate the gear means {12} . The 3 dimensional core image made in the space occupied the tilted rotating plate means {2} would be projected to the secondary imaging space by the second image generating means {1}. The 3 dimensional virtual image {7} shows up on the top of the second image generating means {1}. The second image generating means {1} has light reflecting means inside. The light reflects means on the surface of the double-dish-like container to produce the 3 dimensional virtual image of the 3 dimensional core image at the bottom of the second image generating means {1}. The computer means {16} can record of the information of the 3 dimensional image-object.

The 3 dimensional Image Generator of the type of FIG. 1(B) has the X-Y-axis control means and the 2 dimensional image generating means {18}. The X-Y-Z controller means {5} may be included in the computer means {16}. The Z-axis generator means control the height of the Core 3 dimensional image generating means {23} comprising of the Core image emitter means {15}, the coil means, the magnet/coil means {21}, the spring means {22}. The Core image emitter means {15} vibrate rapidly (about 70 times/sec at least) meanwhile the 2 dimensional image is projected by the 2 dimensional image generating means so that the resultant image on the Core 3 dimensional image generating means {23} create the 3 dimensional image. The spring means {22} pull/push the coil means when the force between the coil means and the magnet/coil means are made by the application of the voltage on the coil means. Since the Fucks law can be used here, the voltage on the coil means correspond to the height of the coil means. Therefore, the voltage applied to the coil means {20} controls the height of the Core image emitter means {15}. In each height, 2 dimensional image is projected to produce the 3 dimensional core image. The 3 dimensional core image made in the 3 dimensional image generating means {23} would be projected to the secondary imaging space by the second image generating means {1}. The 3 dimensional virtual image {7} shows up on the top of the second image generating means {1} that has light reflecting means inside. The light reflects means on the surface of the double-dish-like container to produce the 3 dimensional virtual image of the 3 dimensional core image at the bottom of the second image generating means {1}. The computer means {16} can record of the information of the 3 dimensional image-object.

The 3 dimensional Image Generator of the type of FIG. 1(C) has the multiple light beams such that the many of the light beams focus at the same point to create the brightest point in a medium like gas, liquid, vapor, and solid material in which the user can observe the light beam. Each light beam is dim enough that only brightest point is effective to produce the proper virtual point. By running the brightest point, the 3 dimensional virtual image shows up.

The FIG. 1(D) shows the movement of the 3 dimensional image generating means {23},which is the movement of the 2 dimensional image on the Core image emitter means {15}

The 3 dimensional Image Generator of the type of FIG. 1(E) comprise of the focus changeable lens means {25}, the X-Y light emitter means {27}, the focus changeable lens controller means {28}, and the computer means {16}. The X-Y light emitter means may emit the diverging light on the different position (FIG. 1(E2)). The diverging point is focused by the focus changeable lens means {25} to create the virtual light point means. The focus changeable lens controller means control the focus of the focus changeable lens means. Examples of the focus changeable lens are given in the FIG. 1(E1). FIG. 1 (E) (i) shows the acoustic crystal lens that can change the focus point depending on the applied voltage. FIG. 1 (E) (ii) shows the animal eye lens means or the rubber lens that deform the shape according to the force exercised so that the lens changes the focus point depending on the force exercised. FIG. 1 (E) (iii) shows the combination of optical lenses. By shifting one or some of the lenses, entire focal point changes.

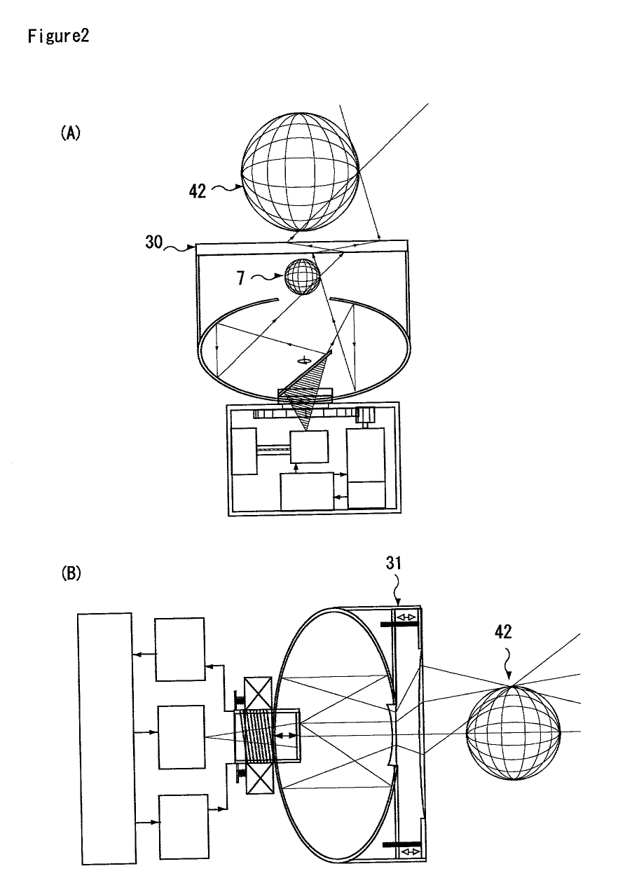

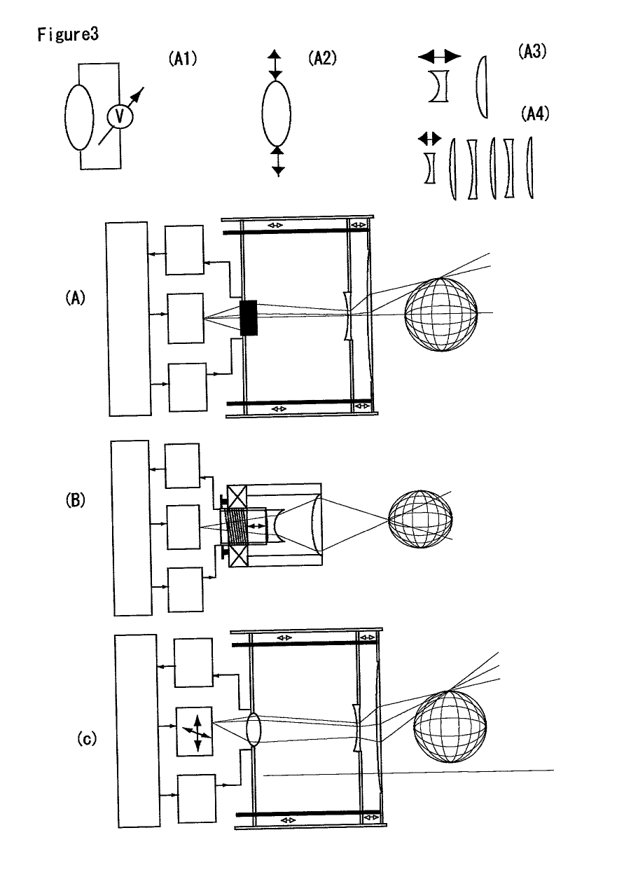

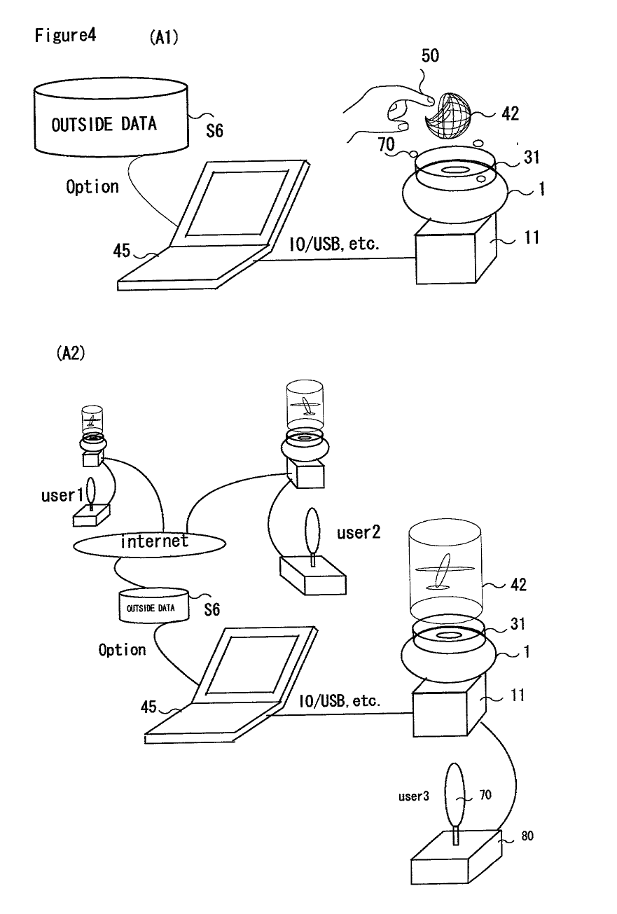

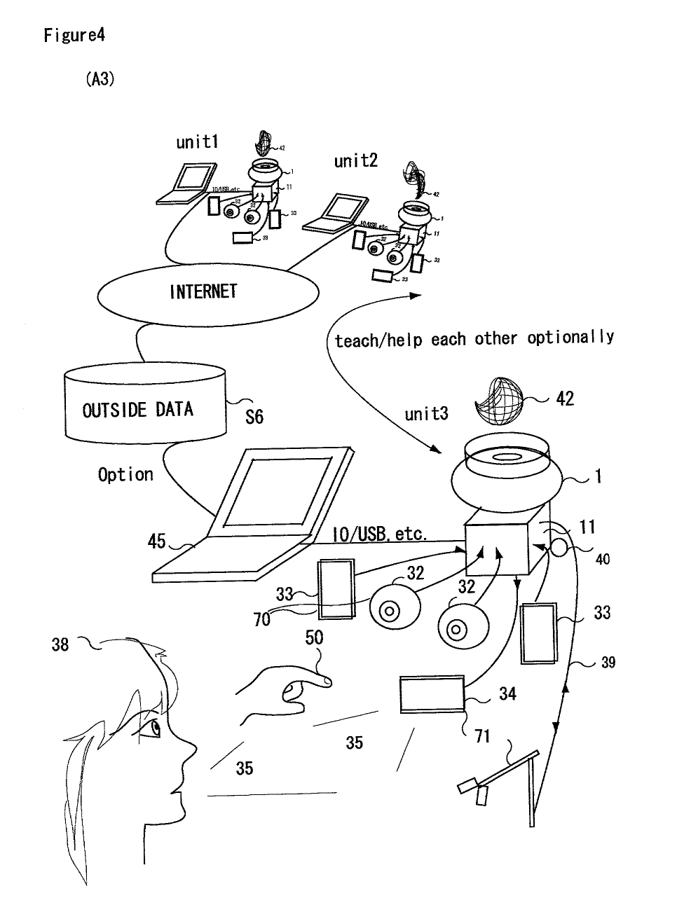

FIGS. 2-7—Additional Embodiments

The example of the 3 dimensional Image Generator of the type of FIG. 2 (A) comprise of the 3 dimensional image generating means of FIG. 1 (A) and the size modifier means (Type I) {30}. The size modifier changes the size and position of the 3 dimensional image created by the 3 dimensional image generating means of FIG. 1 (A).

The example of the 3 dimensional Image Generator of the type of FIG. 2 (B) comprise of the 3 dimensional image generating means of FIG. 1 (B) and the size modifier means (Type I) {31}. The size modifier means (Type II ) modifies the light path to adjust the size and position of the core 3 dimensional image to get the final 3 dimensional image before the secondary 3 dimensional image is generated. In FIG. 2 (B) shows the example of the size modifier comprising a combination of the focus changeable lens means {25} such as acoustic crystal lens and/or optical lens means {58} such as a concave lens and a convex lens.

FIG. 4(A1) shows the example of general view of the 3 dimensional Image/Object Generator connected to a computer that could be connected to the outside database that has 3 dimensional image-object information. These could be connected by normal IO port, USB, network card, any connecting means. By using the input device means {70}, the main control means calculates the position of the input device means and modify the change.

FIG. 4 (A2) shows the example of the 3 dimensional virtual object generator with the force feedback generator means such as force feedback joystick. Many of them are connected by network card so that plurality of users can communicate at once. They can feel the force to each other.

The intelligent system comprising the artificial intelligence. An example of said intelligent system is a device that can have abilities such as to communicate with users, to listen from environment means such as users and other unit of this device, other devices, other units of this system, and other systems, to talk to such as users and other unit of this device, other devices, other units of this system, and other systems, to look at visual information, to learn new things, to think, to induce, to deduce, to analyze, to create, to make to judgments, to act, to control emotion, to understand and solve problems, to understand and solve mathematical problems, and to construct sentences and languages. FIG. 4 (A3) shows the example of intelligent device means with components such as 3 dimensional virtual object generator with eyes means such as a camera, ears means such as a speaker, mouth means such as a speaker, manipulating means such as a robot hand and moving means such as a wheel with a motor, and a intelligent control means such as an artificial intelligence. The diagram/flow chart of an example of the intelligent control means such as super intelligent control means as designed in FIG. 11 (A2).

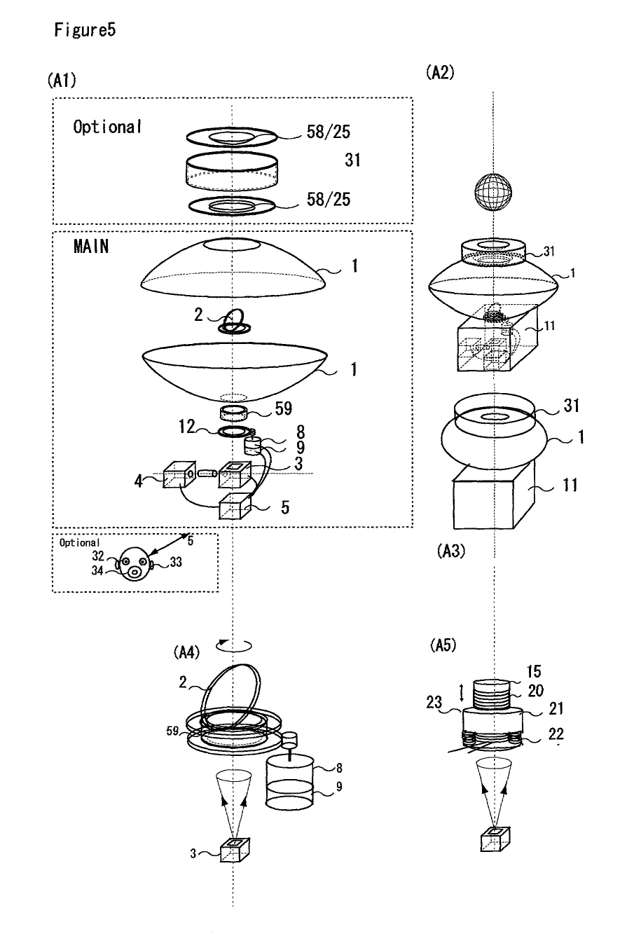

FIG. 5 (A1) shows the example of the parts and structures of the intelligent system and 3 dimensional virtual object generator. This example has X-Y-Z controller means and/or intelligent system unit means {5}, the light source generating means {4}, the 2 dimensional image generating means, {3}, the motor means {8}, the encoder means {9}, the gear means {12}, joint column means and the bearing means {59}, the tilted rotating plane means {2}, the second image generating means {1}. Optionally, it has the size modifier means {1} and the interface means comprising eye means {32}, ear means {33}, and mouth means {34}.

FIG. 5 (A2) shows an example 3 dimensional virtual object {7} and the angled view of the example of the intelligent system and 3 dimensional virtual object generator.

FIG. 5 (A3) shows the symbol picture of the example of FIG. 5 (A1).

FIG. 5 (A4) shows the example of 3 dimensional core image generating means comprising of the tilted rotating plate {2}, and the body and gears and motors. The 2 dimensional image is projected from the bottom to the half transparent rotating plate or the plate display the 2 dimensional image.

FIG. 5 (A5) shows the example of the 3 dimensional core image generating means {23} comprising of the Core image emitter means {15}, the coil means {20}, the magnet/coil means {22}, and spring means {22}. 2 dimensional image is projected to The Core image emitter means {15} or The Core image emitter means displays the 2 dimensional image meanwhile The Core image emitter means {15} vibrates very fast (about 70 time/sec).

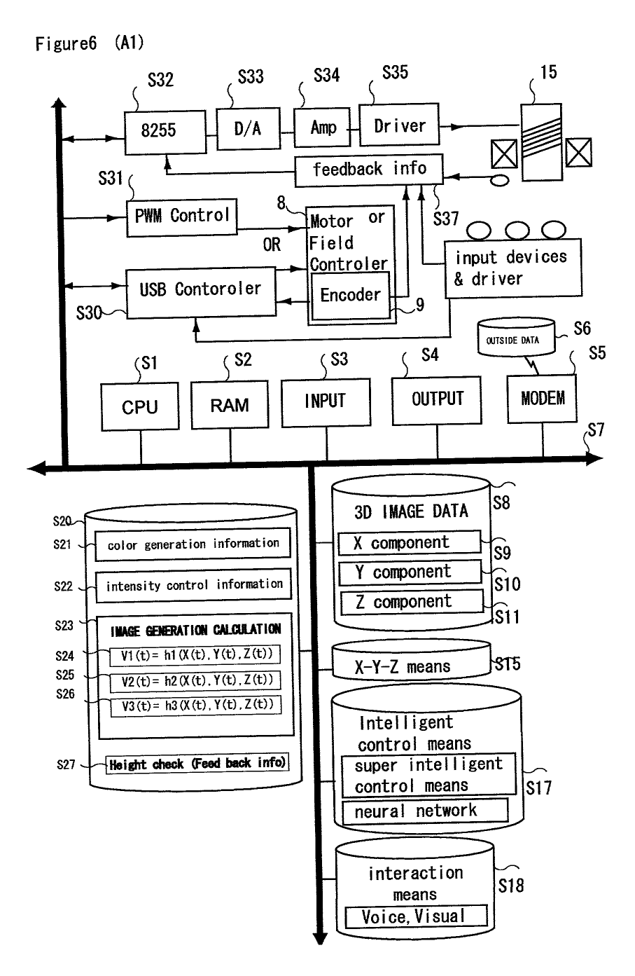

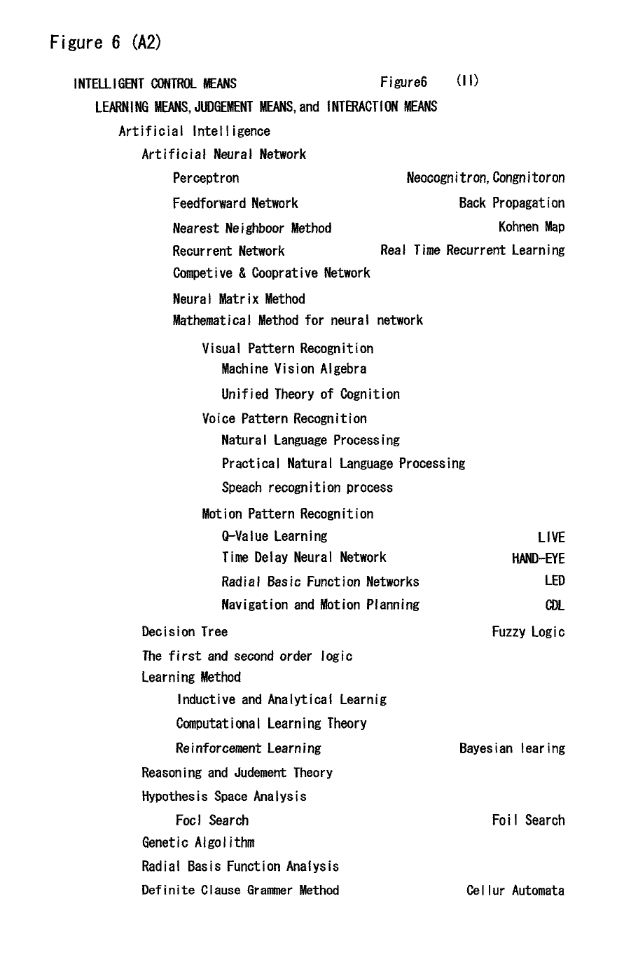

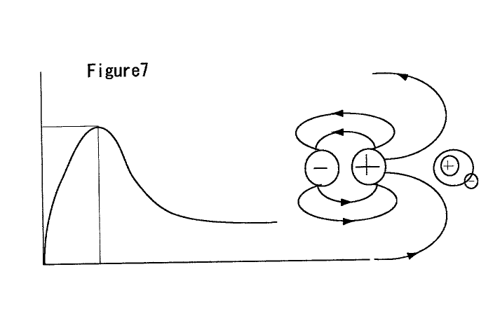

FIG. 6(A1) shows the examples of diagram of the drivers of the 3 dimensional image-object generator with intelligent system.

{S8-15} and {S20-27} shows the control information of 3 dimensional virtual object generator controlled by {S1-7} and {S30-37}. {S17,18} shows the intelligent control means attached and interaction information to have the device to be intelligent so that users and other devices/system can communicate intelligently (as human communicate each other.)

FIG. 6 (A2) shows the examples of the components that can be used for constructing the intelligent control means

FIG. 7 shows the example of making the virtual coulomb field to create the virtual touch by dipole Coulomb field. The dipole is charged very high so that for example the molecules in user's finger can feel the tough.

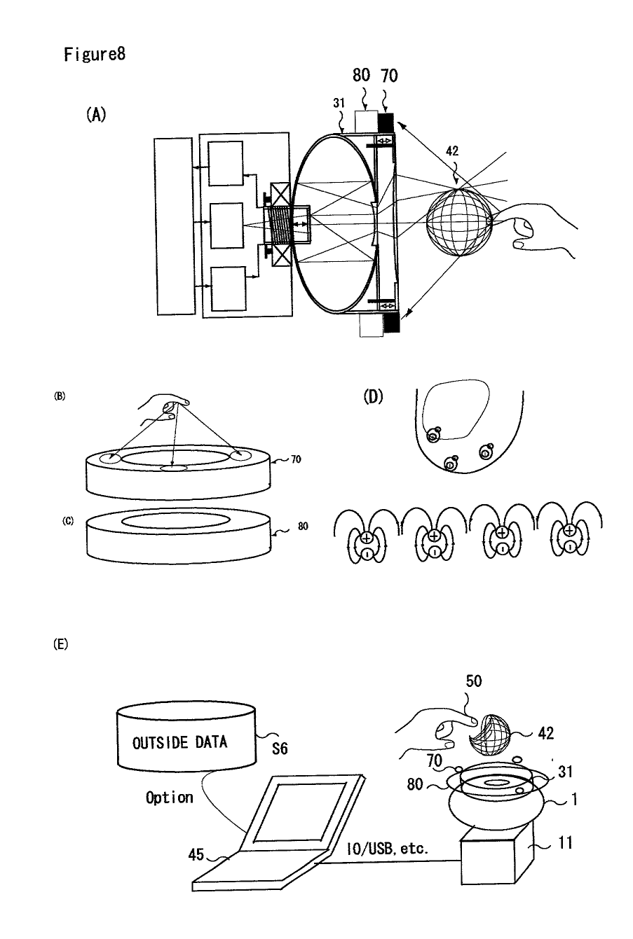

FIGS. 8-12—Alternative and Other Embodiment—and Examples

FIG. 8 (A) shows the example of input device means embedded device. The examples of input device means are infrared detecting device, visual image processing device, radio detecting device, and ultra sonic detecting device. The input device finds the position of the hand, finger or the pointing devices.

FIG. 8 (B) shows the example of the input device means with infrared detector. For example, the computer calculates the delta temperature change from each infrared detectors (at least three detectors). By integrating them, it would calculate where the finger is.

FIG. 8 (C) shows the example of the field generating means. This is made in the way the FIG. 7 shows.

FIG. 8 (D) shows the example of field generating means. The dipoles of 2 opposite poles of a field such as coulomb field, electric-magnetic field, gravitational field, light field, field created by elementary particles, super-strings are put together to create the virtual field points.

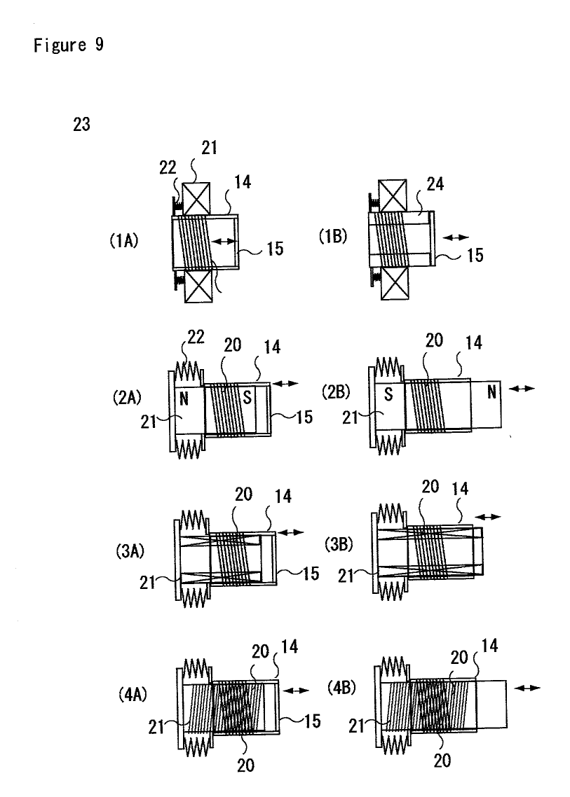

FIG. 9 show the examples of the 3D image generating means {23}.

(1A) The core image emitter means {15} and the column means {14} with the coil means {20} are in magnet/coil means {21}.

(1B)The core image emitter means {15} and the column means {14} with the coil means {20} is in magnet/coil means {21}. The column means {14} is made of a ferromagnetic material means {24} such as iron and super alloy.

(2A) The core image emitter means {15} and the column means {14} with the coil means {20} is surrounding the magnet/coil means {21}.

(2B) The column means {14} with the coil means {20} is surrounding the magnet/coil means {21}.

(3A) The core image emitter means {15} and the column means {14} with the coil means {20} is surrounding the magnet/coil means{21} that has a ring shape.

(3B) The column means {14} with the coil means {20} is surrounding the magnet/coil means {21} that has a ring shape.

(4A) The core image emitter means {15} and the column means {14} with the coil means {20} is surrounding the coil means {21}.

(4B) The column means {14} with the coil means {20} is surrounding the coil means {21}.

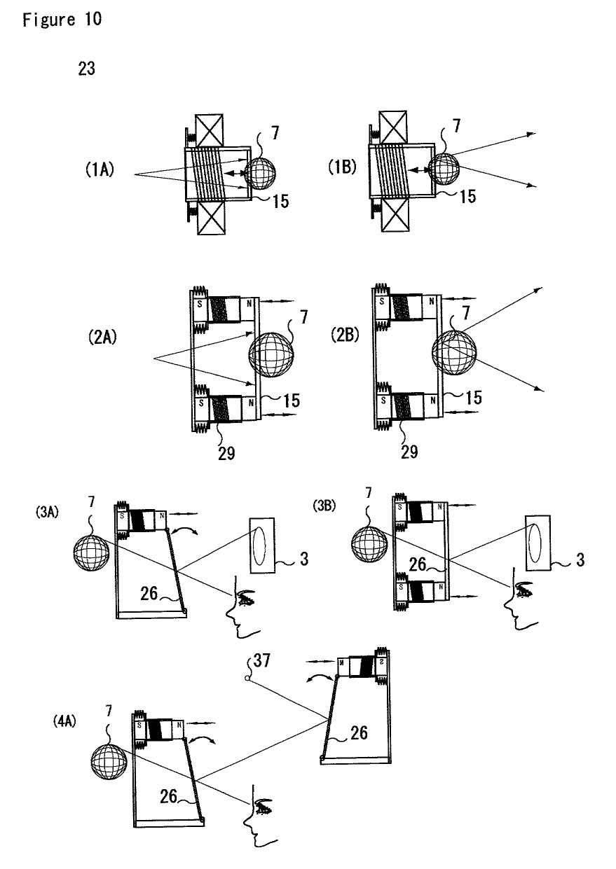

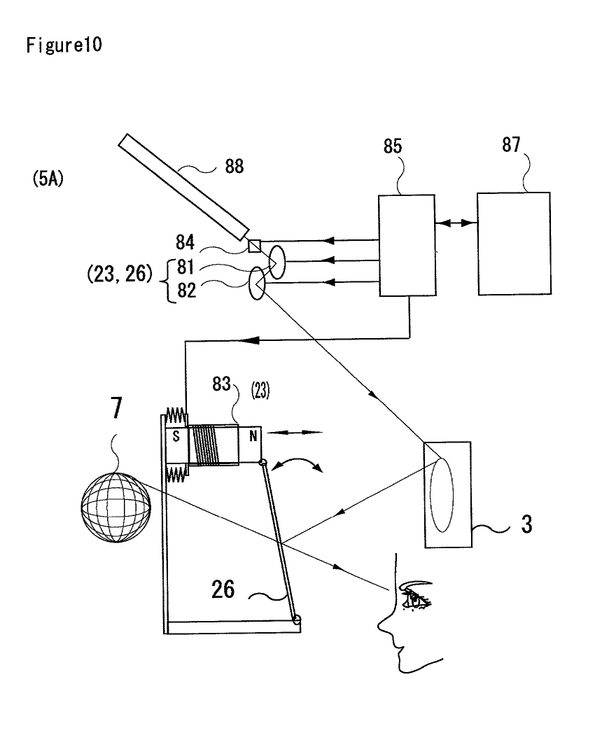

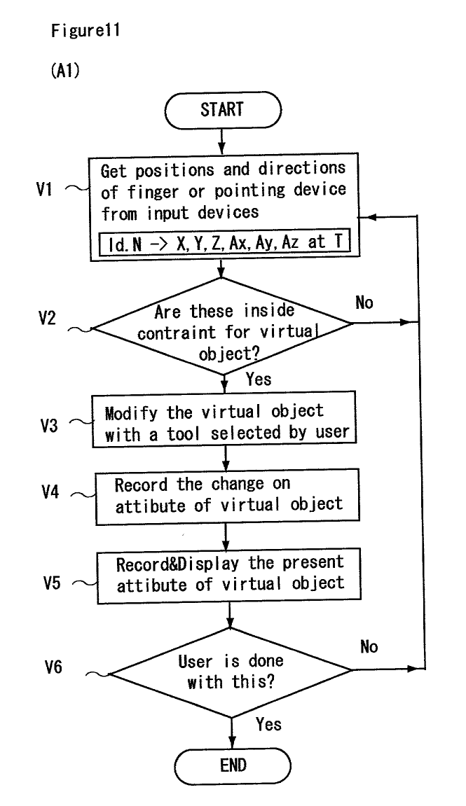

FIG. 10 shows the 23 3 dimensional image generating means {23} and its performance.

(1A) The 2 dimensional image is projected to the core image emitter means {15} that is half-transparent and diffuse and emit the light. The movement of the core image emitter means {15} with the projected 2 dimensional image makes a 3 dimensional virtual image {7}.

(1B) The core image emitter means {15} such as liquid crystal display means emits the 2 dimensional image. The movement of the core image emitter means {15} with the 2 dimensional image makes a 3 dimensional virtual image {7}.

(2A) The 2 dimensional image is projected to the core image emitter means {15} that is half-transparent and diffuse and emit the light. One or more solenoid means {29} moves the core image emitter means {15} to create the 3 dimensional virtual image.

(2B) The 2 dimensional image is emitted by the core image emitter means {15} such as a liquid crystal display. One or more solenoid means {29} moves the core image emitter means {15} to create the 3 dimensional virtual image.

(3A) The reflector means {26} moves angularly due to the solenoid means {26}. The reflector means {26} reflect the 2 dimensional images generated by the 2 dimensional image generating means. The user can view a 3 dimensional virtual image {7}.

(3B) The reflector means {26} shifts due to one or several solenoid means {26}. The reflector means {26} reflect the 2 dimensional images generated by the 2 dimensional image generating means. The user can view a 3 dimensional virtual image {7}.

(4A) The reflector {26} moves angularly due to the solenoid means {26}. The combination of the reflector means movements and light source {37} create the virtual point and a 3 dimensional virtual image {7}.

(5A) shows the diagram of a specific example of 3 dimensional virtual image-object generating means. This works practically made by the inventor in 1995.

FIG. 11 (A1) shows the flow chart of the interaction between user's hand, finger, or pointing device and the virtual object.

{V1} First it would get the position and orientation of users finger, hand or a pointing device from input device means such as infrared detector and its control.

{V2} Check if this position and orientation is inside of constraints for virtual image. For example, check if the finger is getting into the virtual object.

{V3} If it is yes, modify or move the virtual object with the tool selected by user.

{V4} Record the change on the attributes such as position and shape of virtual object.

{V5} Record and display the present attributes such as position and shape of virtual object.

{V6} Check if the user likes to continue to use this. If yes, go to {V1}.

Repeat this until user completed this.

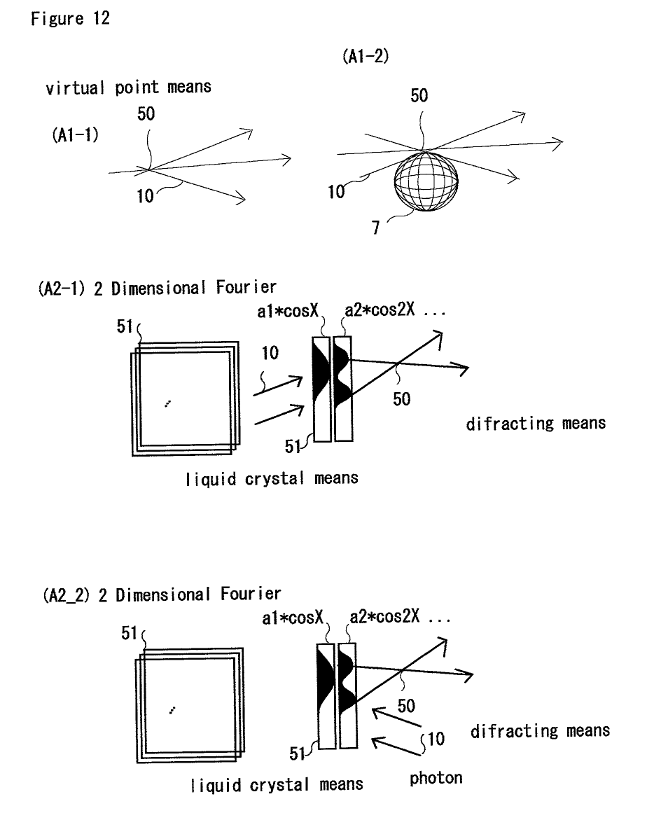

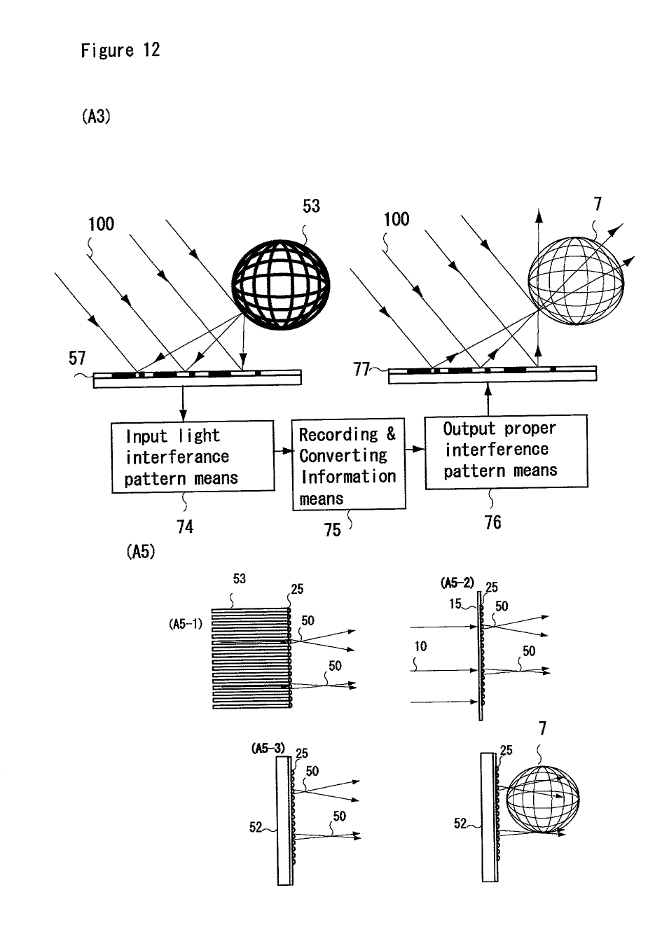

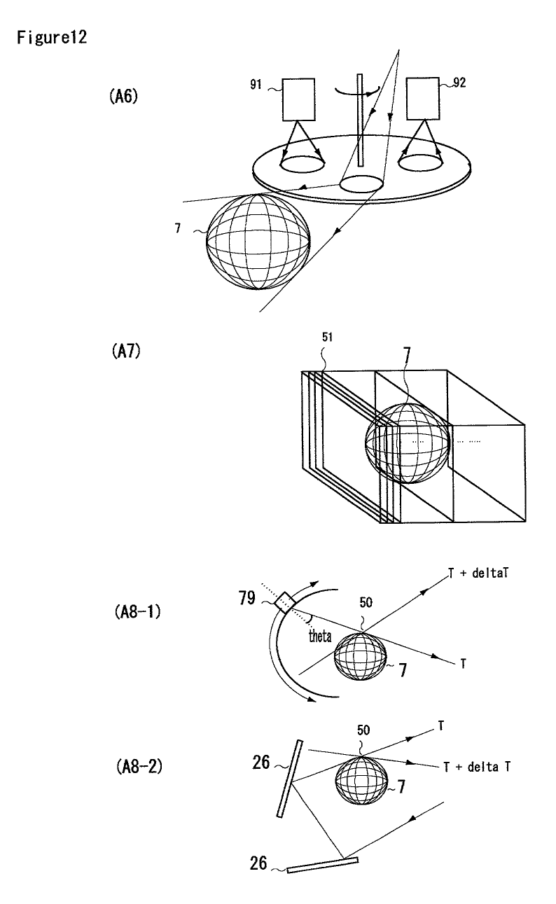

FIG. 12 shows the examples of 3 dimensional virtual image-object generating means.

(A1-1) shows the simplest virtual point {50} with light rays {10}.

(A1-2) shows the plurality of virtual points creating a 3 dimensional virtual image {7}.

(A2-1) and (A2-2) shows the diagram of the superposed liquid crystal sheet means {51} designed from the Fourier Analysis Means. Each of the sheet has cosine pattern cosine(x*y) that changes the density of color, a1, a2, ,aN. This makes the beam to diffract to create a 3 dimensional image {7}. In (A2-1), the beam comes from back. In (A2-2), the beam comes from front.

(A3) shows the diagram of the output device to create 3 dimensional virtual image {7} and the input device means {70} of the real 3 dimensional object. The light, preferably coherent light {100} is emitted to the real 3 dimensional object. The reference light and the reflected light on the object interfere to make a pattern on the photo-sensor means {57}. The input light interference pattern means {74} would be recorded, analyzed, and converted by recording and converting information means {75}. The recording and converting information means {75} send the resultant information output proper into the image generating plate means {77}. The reference light, preferably the same wave length as the reference light of the input light interference pattern means would be projected into the image generating plate means {77} to generate the 3 dimensional virtual image {7} . The pattern on the image generating plate means {77} may be similar/opposite to the pattern on the photo-sensor means.

(A5) shows the diagram of an example of the device to create 3 dimensional virtual image {7}.

(A5 -1) shows the example way that focus changeable lens {25} is top of each light fiber {53}. The focal distance difference on each unit creates the depth difference. The light fibers {53} are distributed in 2 dimensional space. Therefore, the resultant image becomes 3 dimensional virtual image {7}.

(A5-2) shows the example way that the focus changeable lens {25} is top of the core image emitter means {15}. The core image emitter means {15} has 2 dimensional image. The focal distance difference on each unit creates the depth difference in the virtual point. Therefore, the resultant image becomes 3 dimensional virtual image {7}.

(A5-2) shows the example way that the focus changeable lens {25} is top of diffuser means core image emitter means {15}. The core image emitter means {15} has 2 dimensional image. The focal distance difference on each unit creates the depth difference in the virtual point. Therefore, the resultant image becomes 3 dimensional virtual image {7}.

(A5-3) shows the example way that the focus changeable lens {25} is top of the each pixel of the liquid crystal display {52}. The liquid crystal display {52} has 2 dimensional image. The focal distance difference on each unit creates the depth difference in the virtual point. Therefore, the resultant image becomes 3 dimensional virtual image {7}.

(A6) shows the diagram of an example of the device to create 3 dimensional virtual image {7} . The writer means {91} scatters powder means such as powder and plasma particle to a moving plate. The reference light is given to the proper spot so that it generates 3 dimensional virtual image {7}. The powder means is erased by the eraser means that cleans up the power means so that it can up date the images.

(A7) shows the diagram of an example of the device to create 3 dimensional virtual image {7}). The plurality of the originally transparent liquid crystal sheets {51} is aligned in a space. One of sheet turns a half-transparent or non-transparent when the voltage is applied. A 2 dimensional image is projected on this half-transparent or non-transparent liquid crystal. By shifting the voltage on half-transparent or non-transparent liquid crystal, 2 dimensional image created with z-axis result the 3 dimensional image.

(A8-1) shows the diagram of an example of the device to create 3 dimensional virtual image {7}. The direction changeable emitter {79} means run angularly. At each angle, the direction changeable emitter {79} emits the light in the proper angle. By moving the direction changeable emitter {79} very fast (about 3600 times/sec. or more) from one point to the other having the same focusing point, the light emitted would create the virtual point. By changing the position of the virtual point, it would create the 3 dimensional virtual image {7}.

(A8-2) shows the diagram of an example of the device to create 3 dimensional virtual image {7}. The reflector means reflect the light rays having different angle at each short time (about 1/3600 sec or shorter). By reflecting the light rays in proper way, they create the virtual point and the 3 dimensional virtual image {7}.

Advantages

As mentioned, this invention has advantages in

1. This device of invention can learn, think, create like a human beings and communicate like a human beings.

2. User can view the mind/image this device of invention is thinking and interact with the mind/image directly as well as indirectly.

3. The device can operate the 3 dimensional virtual image-object by interacting with user on the image-object and by using computer input device means.

4. The device can imagine the object image and show it to the users when users give command vocally or visually.

5. The device can learn and improve itself acquiring new information/materials from users and the other information source.

6. The device can communicate with each other and users effectively.

7. The device can associate the information so that it would induce, deduce, guess, and create the desired result as far as the proper basis of the desired result is given to the knowledge base, and users other entities can get these results through the communication of their choice.

8. The device is integrated enough to work like a human brains and potentially exceeds the capacity of human brains.

9. The device can copy their acquired information to each other. thinking.

10. The device is safer and user-friendly to users

11. The device can display the 3 dimensional object or images in real time (run time)

12. The device can display the 3 dimensional object or images that can be viewed by the multiple users without special glasses

13. The device can display the 3 dimensional object or images in the space only by light.

14. The device can be used for longer operating time

15. The device can change the size and position of the 3 dimensional images

16. The device can display objects from plus infinite to minus infinite distance 3 dimensional volume.

17. The device can be made more inexpensively.

18. The device can create virtual touch to the multiple users without a headset or special glass, and the device can give more realistic interaction with user than 2 dimensional screen interaction.

Operation—FIGS. 5, 6, 8, 11

A Users can start talking to the device of invention for the request of what they like to do. The device responds to the command to the users with its mind verbally, visually, and other means of output such as moving. The device may have its opinion for the event the user is handling. The device can communicate with other devices, systems and environment.

A user can simply view the 3 dimensional image-object by the 3 dimensional virtual image-object Generator

A user can record the 3 dimensional image-object by the 3 dimensional virtual image-object Generator, and view the 3 dimensional image-object in the desired time of period. If necessary, it can be replied many times.

Users view the 3 dimensional image-object made by the 3 dimensional image object Generator. The input device means monitors user's movement such as finger or hand movement. The computer calculates the interaction between image-object and the finger and hand, and display/generate the modified

3 dimensional virtual image-object.

Users teach their commands interacting with the invention by language or by visual language such as finger or hand movement. The device talks back to the users if its action is correct or how well done. Users gives response, and the invention learns the commands depending on the response. The invention shows what the invention is thinking by showing to the 3 dimensional virtual images to users. The invention can learn new materials by itself or by users visually looking at new materials or by listening sound, the language and music or by connecting to the information source such as electric dictionary or Internet.

Conclusion, Ramifications, and Scope

By the device of the invention, multi-users can communicate with this device visually, verbally as human beings communicate each other. The device of invention can learn, recognize, classify, associate, induce, deduce, analyze, think feel, and create, through existing and new information from users, devices, systems, and environment.

Also, by this invention, multi-users can view the 3 dimensional objects or images in real time (run time) without special glasses in the space only by light safely. Optionally the users can have more selection on the size and position of 3 dimensional objects or images and so it would be more convenient when displaying the molecules. Optionally, users can have much bigger virtual 3 dimensional space in infinite distance so that user would not be restricted by the small volume of the 3 dimensional image. Also, users can move and modify the 3 dimensional virtual object.

Also, optionally user can touch the virtual image so that it would be more the realistic. Also, optionally users can interact with this invention by handling the virtual object, giving visual commands, talking with the invention, teaching a finger movements, letting the invention learn your command.

I claim:

1] The device that displays multi dimensional virtual object means in the space in real time composing the virtual point means and the generating plurality of said virtual point means.

2] The device of claim [1] wherein said virtual point means is composed of a focus point in a field created by
e1) photons
e2) electrons
e3) atoms
e4) molecules
e5) gravitons
e6) elementary particles
e7) super strings
e8) a combination of I) through VII)

3] The device of claim [1] wherein said generating plurality of said virtual point means is composed of
a) a movement of said virtual point means,
b) a distribution of said virtual point.

4] The device of claim [3] wherein said movement of said virtual point means is composed of
a) a focus point created by a movement of interacting material means comprising
e1) a reflector means comprising a mirror, a reflective plastic sheet, electric magnetic field generator, mass
e2) a diffuser means comprising a half-transparent plastic sheet, liquid crystal plate, electric magnetic field generator, and a mass
e3) a lens means comprising optical lens, a combination of optical and electromagnetic lens, electric magnetic field generator, and a mass
e4) a diffraction material means comprising a grid, a diffraction grating, and a liquid crystal, electric magnetic field generator, and a mass
e5) a combination of I), II), III), and IV)
with beams means comprising
v1) photons
v2) electrons
v3) atoms
v4) molecules
v5) gravitons
v6) elementary particles
v7) super strings
v8) a combination of I) through VII)

5] The device of claim [4] wherein said movement of material means is composed of
a) a movement of rotation of the tilted said interacting material means such as diffuser, reflector, and lens by a ring which allow 2 dimensional image to be projected from the bottom,
b) a movement of angled shift of said interacting material means such as diffuser, reflector, and lens to create said virtual point means,
c) a movement of shifting said interacting material means such as diffuser, reflector, and lens
d) a movement of virtual point created by the multiple beam overlapping means in the half-transparent material means such as gas, vapor, liquid, and solid material.

6] The device of claim [5] wherein said movement of said shifting the interacting material means is composed of
said interacting material means plate attached with a column around which the coil means are rapped and the column and said interacting material means shift due to the applied voltage on sail coil means and due to the interactive force between the magnetic field created by magnet means and said coil means and said column means meanwhile the interacting material means hold the said virtual point to create the 3 dimensional image object.

7] The device of claim [5] wherein said movement of said shifting the interacting material means is composed of
said diffuser means plate attached with a column around which the coil means are rapped and the column and said interacting material means shift due to the applied voltage on sail coil means and due to the interactive force between the magnetic field created by magnet means and said coil means and said column means and due to the force made by spring means meanwhile the diffuser means plate emit the 2 dimensional image and shift in the third direction to create the 3 dimensional image.

8] The device of claim [3] wherein said a distribution of said virtual point is composed of
a) a movement of virtual point created by the focus changeable lens means comprising
i) a lens shaped acoustic crystal that changes the focus by the voltage applied,
ii) a animal eye and the rubber lens that changes the focal point by the exercised force,
b) a movement of the source means such as an origin of light.
c) a combination of optical lens that changes the focal point as a whole by the moving one or a plural of lenses.
d) a combinations of a), b), and c)

9] The device of claim [3] wherein said movement of said virtual point means is composed of
a) reference light and pattern generating means comprising
e1) 2 dimensional fourier pattern generation means comprising the density difference with cosine altitude and frequency on a changeable material means comprising
i) the liquid crystal
ii) density changeable gas
iii) density changeable liquid
e2) a simple 2 dimensional pattern generation by liquid crystal
e3) a creation of pattern using a powder means such as powder and plasma particles
e4) a creation of pattern by density difference of liquid crystal, gas, liquid.
b) generating 3 dimensional pixel light means comprising a creation of virtual light on the pixel with which said focus changeable lens is set.

10] The device that create 3 dimensional virtual object in the space in real time comprising
a) a computing means comprising
v1) a computer means
v2) a combination of control means
b) a physical means comprising
v1) a first step comprising generating precursor of said virtual object means comprising
i) x axis generating means
ii) y axis generating means
iii) z axis generating means
v2) a middle step means comprising of changing the Position of said precursor of said virtual object comprising
i) a lens means comprising a optical lens, a combination of optical lens, focus changeable lens means comprising an acoustic crystal lens, an animal eye lens, and a combination of optical lens and acoustic crystal, and animal eye lens, and the combination.
ii) a combination of said lens means
iii) a container means comprising a dish and opposite direction ring shaped dish whose inside is a reflecting material means such as silver plastic, silver, and gold.
V3) a final step means comprising of changing the size of said precursor of said virtual object by said lens means.

11] The device of claim [10] wherein said x axis generating means and y axis generating means is composed of x-y image generating means such as
a) a beam display means comprising
v1) a combination of the movement of reflector means comprising mirror to change the path of beam means comprising laser beam to create a image.
V2) a combination of the change in the focus using lens means
b) a liquid crystal display means comprising a liquid crystal, a liquid crystal display
c) a television means comprising of a television, a monitor
d) a electron emitting means comprising of electron-photon emitting device.

12] The device of claim [10] wherein said z-axis generating means is composed of
a) a reflector means comprising a mirror, reflective liquid, reflective solid, reflective gas.
b) a diffracting material means comprising a plastic sheet grid, liquid crystal film, photo film, glass, a mirror, diffractive liquid, diffractive liquid due to the reflection on the rippled surface, diffractive solid, diffractive gas, diffractive gas due to the condensation difference in space and time.
c) a diffuser means comprising a half-transparent plastic sheet, a non-transparent plastic sheet, a half-transparent glass plate, a non-transparent glass plate, optical lens, liquid crystal, acoustic crystal
d) a core image emitter means comprising plastic sheet, glass plate, optical lens, liquid crystal, and acoustic crystal.
e) said lens means comprising a optical lens and focus changeable lens means comprising an acoustic crystal lens, an animal eye lens, and a combination of optical lens and acoustic crystal, and animal eye lens

13] The device of claim [10] wherein said computer means comprising
a) a personal computers
b) a super computers
c) a device with central processing unit
d) any logical calculator
e) any fuzzy and neural logic calculator

14] The device of claim [10] wherein said control means comprising computer control means comprising
a) an output control means
b) an input control means
c) a intelligent control means

15] The device of claim [14] wherein said output control means comprising
a) a pulse width method control
b) a digital to analogue converter and analogue to digital converter control
c) a control for
v1) a motor means comprising
a brush-less motor, brush motor, ultrasonic motor, plastic motor, plane motor,
v2) a solenoid means comprising
a coil body with magnet, a coil body with coil, a coil body with ferromagnetic material such as iron with magnet, a coil body with ferromagnetic material such as iron with coil
v3) an acoustic lens means comprising
acoustic lenses to which voltage can be applied
v4) a liquid crystal means comprising
liquid crystal display, liquid crystal sheet, liquid crystal material, liquid crystal monitor
v5) a lens shift in a combination of optical lenses
d) an emitter for an infrared ray
e) an emitter for a electromagnetic wave
f) an emitter for an ultrasound
g) an output device means comprising
v1) a manipulating robot hand
2) a speaker
v3) a liquid crystal display
v4) a transportation means such as robot legs and wheel
v5) a computer

16] The device of claim [14] wherein said input control means comprising
a) a pulse width method control
b) a digital to analogue converter and analogue to digital converter control
c) a control of input device means comprising
v1) infrared ray detectors
v2) electro-magnetic wave detectors
v3) ultrasound detectors
v4) vision detectors
v5) voice detectors
v6) joystick
v7) mouse
v8) virtual reality glove
v9) driving handle
v10) pad controller
v11) snowboard, ski, skateboard
v12) any combination of I ) through XI)

17] The device of claim [14] wherein said intelligent control means comprising
a) a logical decision-making process means
v1) neural network means
v2) expert system device
v3) fuzzy logic system device
v4) artificial intelligence system device
v5) general decision tree system device
v6) hypothesis space system device
v7) induction and deduction system device
v8) self and teaching learning system device

18] The device of claim [17] wherein said neural network means comprising
a) artificial neural network comprising
v1) a artificial neurons that understand, learn, and judge the command and needs from the users means comprising
i) visual input learning device
ii) voice input learning device
iii) physical input learning device
v2) artificial brain
III) artificial judging computer
IV) artificially created biological decision making device
b) natural neural network such as
v1) human beings
v2) dolphins
v3) animal brain

19] The intelligent system with which user can communicate comprising
a) input device means comprising
v1) infrared ray detectors
v2) electro-magnetic wave detectors
v3) ultrasound detectors
v4) visual image detectors
v5) ear means such as a speaker and voice detectors
v6) eye means such as a video camera and computer camera
v7) sensor means such as a photo sensor, heat sensor, touch sensor, field sensor, sound sensor, visual sensor, position sensor, orientation sensor, speed sensor, acceleration sensor, and gravitation sensor
v8) computer-input means comprising
i) mouse
ii) joystick
iii) touch pad
iv) 3 dimensional mouse
v) location and orientation detecting device
b) output device means
v1) 3 dimensional image display
v2) mouth means such as a speaker and liquid crystal display
v3) manipulating means such as a robot hand a computer and software
v4) computer means such as a computer and digital circuit
v5) communicating device means such as a networking device
v6) a field generator means
i) a coulomb field generating device
ii) a electric magnetic field generating device
iii) a gravitational field-generating device
iv) a generating a field created by particles device
v7) a force feedback generator means
i) a solenoid
ii) a spring
iii) a motor
iv) a force feedback joystick
v) a force feedback mouse
vi) a force feedback virtual reality glove
vii) a force feedback driving handle
viii) a force feedback snow board, ski, skateboard
ix) a force feedback pad controller
x) any force feedback device comprising a combination of i) through
ix)
c) an intelligent control means comprising
v1) a decision tree system
v2) an expert system
v3) a fuzzy logic system
v4) a reasoning and judgment system
v5) a genetic algorithm system
v6) a hypothesis space system
v7) an induction and deduction system
v8) a self and teaching learning system
v9) a first and second order logic system
v10) a learning device comprising
i) q-value learning system
ii) time-delay network system
iii) self-modifying and adjustable system
iv) general learning system
v) super learning system
vi) visual learning system
vii) voice learning system
viii) physical learning system
a1) artificial brain
a2) artificial judging computer
a3) artificially created biological decision making system
v11) a neural network means comprising
a1) pattern recognition system
a2) feed forward network system
a3) back propagation system
a6) nearest neighbor system
a7) alternating classification system
a8) multi-layer neural structure system
a9) recurrent neural network system
a10) matrix neuron system
a11) tensor neuron system
a12) mathematical neuron system
v12) an super intelligent control means

20] The system of claim [19] wherein said super intelligent control means comprising
s1) Learning means comprising
i) acquiring information
ii) self-modifiable pattern recognition and classification
iii) analyzing information
iv) checking information
v) memorizing information
vi) action-taking
vii) feedback the result information with conditional information and action information to acquiring information and repeat the process
viii) analytical learning of dynamic induction and deduction means comprising ((a=>b, b=>c, then a=>c) and (a=>b=>c=> . . . =>z))then “a=>z” is the logical guess of event.
s2) acquiring knowledge means comprising
v1) pattern recognizing and classifying means comprising
a1) character classification method means comprising the homology search of information converting the qualitative information to quantitative statistical information creating the n dimensional analytical space, and it c categorize the information from the modifiable distance map of information, and classifies the information based on the specific characters such as proper-characters and non-proper-characters.
a2) advanced language processing comprising the usage of the mathematical and fuzzy and neural logic association of visual images and language for learning such as induction and deduction process together with the language understanding and construction. It uses the connectivity of the languages and visual languages to associate, analyze, and create the new languages, and the relation of the necessary conditions and sufficient conditions between visual image and language.
a3) system advancing algorithm comprising the method to pattern recognition of the information with multi-layers of neurons that update the weight, connectivity and structural or mathematical connection itself in order to handle all type of complicated logical information that human being can handle, call this as general pattern recognition method means comprising
aa1) when the contradiction occurs, the system updates itself for new classification to create new neural connections or modify the existing connection to create a coherent information system.
aa2) creating the all connections for the units of neurons at first, use the genetic algorithm to find the optimal connection.
aa3) creating the random connections, units, and weight with genetic codes to individual entities, and those entities mates each other to optimize the connections, units, and weight due to the artificially natural selection gives the favor of survival to the fitting individuals to the environment.
v2) general classification means comprising
i) general classification of recognized and classified information
ii) classification of multi-interpretation means comprising
a1) self-classification of information
a2) classification of information by environmental correctness and influence
a3) classification of information by users, devices, and systems
a4) hybrid classification of information of a1), a2), a3), a4)
v3) associating means comprising
i) association of the classified information
ii) association of the classified definition
iii) association of the classified logic
iv) association of new information to the existing information
v) association of information with emotion
vi) general generalization method means comprising the general theory of generalization, that is, the super position of properly modified information of the original information minus the proper threshold value and the repeating this process generalize the information.
vii) general association method comprising the usage of said general generalization method for the association process to find the generally valid the association
v4) learning logic pattern means comprising
i) induction means comprising
a1) logical induction
alpha1equations of induction and hypthesis means comprising
“((ab=a′b′, a=a′)=>(a=a′, b=b′))” is the first guess, and also “((ab=a′b′, ac=a′c′)=>(a=a′, b=b′, c=c′)) is the highest hypothesis space.”
a2) mathematical induction
a3) visual induction
a4) linguistic induction
a5) pattern induction
ii) deduction means comprising
a1) logical deduction
a2) mathematical deduction
a3) visual deduction
a4) linguistic deduction means such as deduction done by the linguistically logical space.
a5) pattern deduction means such as advancing learning method means comprising the dynamical creation of the coherent system for artificial intelligence such as an artificial neural network comprising the neurons connection constructing and modifying process the structure of neural and fuzzy and classical probable connections and embodiment of the contradicting logical connections for the optimal benefits.
V) result correctness checking means comprising
i) checking if result is correct relative to self known information
ii) checking if result is correct relative to outside known information
v6) memorizing means comprising memorization of information means comprising
i) definition
ii) classification
iii) logics
iv) condition, then result
v) condition, then beneficial result
vi) condition, then non-beneficial result
v7) creative means comprising
i) vision construction
visual images creation
ii) language construction
iii) logic construction
iv) hypothesis construction
v) hypothesis hyper plane method means comprising the pattern recognition, induction, deduction of the coherence of the information having an algebra of the fittingness in a hyper plane.
V8) choices generation thought experiments with benefit guess of the choices
S3) instinct means comprising
V1) basic desire
V2) basic logics
V3) motivation to satisfy said basic desire
V4) benefit checking means
i) reward checking
ii) punishment checking
S4) emotion handling means comprising
V2) promotion of desired result
V2) priority making
V3) selection of highest priority
V4) balance checking of benefit and punish
V5) happiness checking
S5) decision-making means comprising decide if the system should take the action
S6) action taking means comprising
V1) output driver means comprising
a1) sound driver
a2) image driver
a3) language driver
a4) manipulating driver
a5) moving driver
v2) satisfaction checking means comprising checking if the result is satisfactory
v3) feedback to the knowledge database about the condition, action, and the result
S7) environment means comprising
V1) physical entity
i) users and creatures
ii) systems and devices
iii) physical materials
iv) computers
v) universe
v2) virtual entity
i) virtual mind space created by individual
A1) imaginary space of other people, devices, systems.
A2) thinking space other people, devices, systems.
A3) self-meditating space other people, devices, systems.
ii) cyber space
iii) information
iv) happiness space
v) spiritual space
vi) truth space
